(19) United States
(12) Patent Application Publication
(10) Pub. No.: US 2023/0264125 A1
(43) Pub. Date: Aug. 24, 2023

(54) FILTER DEVICE

(71) Applicant: HYDAC FILTERTECHNIK GMBH, Sulzbach/Saar (DE)

(72) Inventors: Michael SAKRASCHINSKY, St. Ingbert (DE); Dirk RÖDER, Saarbrücken (DE); Martin BRAUNE, Brebach-Fechingen (DE)

(21) Appl. No.: 18/017,533

(22) PCT Filed: May 28, 2021
(86) PCT No.: PCT/EP2021/064343

§ 371 Date: Jan. 23, 2023

(30) Foreign Application Priority Data
Jul. 24, 2020 (DE) 10 2020 004 489.1

(51) Int. Cl. B01D 29/96; B01D 29/15; B01D 35/153

(52) U.S. Cl. CPC B01D 29/96; B01D 29/15; B01D 35/153; B01D 2201/4092; B01D 2201/16; B01D 2201/295

(57) ABSTRACT

Disclosed is a filter device having a filter housing (10) that comprises at least two ports (12, 14), such as an inlet for unfiltered matter and an outlet for filtrate, and accommodates a replaceable filter element (16), which is characterized in that by a shut-off device (18) a fluid-conveying connection between the inlet (12) and the outlet (14) that exists in an open position, is blocked in a blocking position, and in that by an actuation device (20) the shut-off device (18) can be brought into these individual positions.

The invention relates to a filter device having a filter housing that comprises at least two ports, such as an inlet for unfiltered matter and an outlet for filtrate, and accommodates a replaceable filter element.

From the post-published DE 10 2019 008 741, a generic filter device is known having a filter housing, which likewise has a port for the supply of a flow of unfiltered matter and a further port for the discharge of a filtrate flow, comprising a hollow-cylindrical filter element containing a filter material, which filter element is, for the filtration of the flow of unfiltered matter, installed between the respective ports, and comprising a flow introduction device for routing the flow of unfiltered matter inside the filter housing, which flow introduction device is also used to route the filtrate flow inside the filter housing and comprises a partition wall, which, using its mutually opposite wall faces, against which the flows are directed, routes the flow of unfiltered matter and the filtrate flow separately from each other, and which flow introduction device is penetrated by a fluid duct, one end of which opens out into the interior of the filter element and the other end of which opens out in the direction of one of the two ports.

In this way, complicated, curved fluid ducts in the filter head of the filter housing can be dispensed with and replaced by ducts of straight-line design, which helps to avoid pressure losses when feeding and discharging the unfiltered matter or filtrate flow due to turbulence and the associated cavitation phenomena that damage the material, and also enables an energetically favorable filtration operation in the course of particle cleaning by means of the filter element.

Based on this post-published prior art, the invention addresses the problem of further improving this known solution, while retaining its advantages, in such a way that a service-friendly filter element change is achieved in a special way. A filter device having the features of claim 1 in its entirety solves this problem.

By using a shut-off device to block, according to the characterizing part of patent claim 1, a fluid-conveying connection between the inlet and the outlet that exists in an open position, in a blocking position, and by using an actuation device to bring the shut-off device into these individual positions, in particular the fluid supply to the filter housing can be shut off, rendering opening the filter housing and replacing a used filter element with a new element considerably easier, because it is not necessary to constantly reckon with fluid in the form of unfiltered matter emerging, and the amount of fluid which may escape to the outside of the filter device is kept to a minimum. Although a valve in a connecting line to the fluid inlet is also blocked in known device solutions for an element change, the amount of fluid remaining in the connecting line between the valve and the inlet is considerable, however, and results in an increased amount of unintentionally escaping fluid during an element change. This is avoided using the device solution according to the invention, because the fluid-conveying connection between the inlet and the outlet between which the filter element is accommodated is closed by means of a shut-off device, which can be operated by an actuation device, preferably by manual operation. The preferred installation position of the filter device is vertical with vertical longitudinal alignment of the filter housing.

It is particularly advantageous if additionally a fluid outlet is provided at the filter housing, preferably at the bottom end, which, operated after the fluid-conveying connection between the inlet and the outlet has been shut off, enables the remaining fluid to be discharged from the filter housing to the outside into a safe environment, e.g. into a collecting vessel, preventing any environmental pollution caused by leakage of the fluid, such as hydraulic oil.

In a particularly preferred embodiment of the filter device according to the invention, provision is made for the shut-off device to have a partition wall, which, viewed in the longitudinal direction of the filter housing, is set at an angle, the top face of which partition wall, in the open position, opens out into one port and the underside of which partition wall opens out into the respective other port, and for the partition wall, brought into the blocking position, preferably by swiveling, by means of the actuation device, to shut off at least the inlet by means of at least one blocking element. Because the inlet is blocked, the inside of the filter housing is free of fluid flowing in on the feed side, and any fluid or liquid still present in the filter housing can be drained via the outlet at the bottom end of the filter housing. Particularly preferably, however, the shut-off device blocks both the inlet and the outlet in the operated state without the need for additional valve devices in the connecting lines to the inlet and the outlet.

In a further preferred embodiment of the filter device according to the invention, provision is made for the elliptically configured partition wall to have sealing means along its outer circumference and for the partition wall to be penetrated by an opening, which is fluidically connected to the interior of the hollow cylindrical filter element. In this respect, the inclined, plate-like partition wall bears the seal at its outer circumference, which seal, viewed in the vertical operating position or open position, runs above one port and below the other port, respectively. The fully circumferential arrangement of the seal between the outer circumference of the partition wall and the assignable inside of the housing of the filter head renders achieving a particularly good sealing effect between the flow of unfiltered matter and the filtrate flow during filter operation possible. During normal filtration operation, the inclined, plate-shaped partition wall is pressurized by fluid, which pressure is transferred to the seal, which then ensures the desired sealing effect by bearing against the inside of the filter housing at a presettable sealing force. When the filter element is not in use or is replaced, there is no fluid pressure, pressure-balancing relieves the partition wall and seal, and the partition wall/seal assembly can then be swiveled largely without force. The seal is a multi-layer molded seal, which, while providing a good sealing effect, nevertheless offers little resistance to the swivel motion of the separator plate and is abrasion-resistant.

In a further preferred embodiment of the filter device according to the invention, provision is made for the opening in the partition wall, as part of a connecting device, to be at least partially delimited by a threaded section, which is used to secure the filter element in the filter housing via its assigned threaded section as a further part of the connecting device. In this way, the filter element can be spatially and functionally separated from the shut-off device and replaced by a new element of the same type, wherein the shut-off device remains in the filter housing in the area between the inlet and the outlet.

To ensure such safe retention in the filter housing, preferably provision is made for the partition wall to have a delimiting element, which interacts with adjacent housing parts such that a guide device is used to guide the partition wall between the open and the closed position, preferably by 90°, in a swiveling manner, by means of the actuation device in the filter housing. In this way, the actuation device can be used to swivel the partition wall and its blocking element as a component of the shut-off device across a small swiveling range of approximately 90°, such that switching between the open position and the blocking position and vice versa can be performed in a functionally reliable manner.

Preferably, provision is made for the guide device to have at least one latch, preferably on the shut-off device, which latch is accommodated in a guide groove, preferably in the filter housing, in such a manner that the shut-off device can be rotated radially and in the axial direction, viewed along the longitudinal direction of the filter housing, is accommodated in the filter housing in a stationary manner. In this way, the shut-off device is secured in a secure, rotatable manner in the filter housing.

In a further preferred embodiment of the filter device according to the invention, provision is made for the inlets and the outlets of the ports to be disposed, as viewed in the longitudinal direction of the filter housing, diametrically opposite from each other in the filter housing, extending in at least one and the same plane. In this way, fluid is guided in the filter housing in a particularly space-saving manner, and the straight supply and discharge ducts reduce the manufacturing effort and costs for the entire filter device solution.

In a further preferred embodiment of the filter device according to the invention, provision is made for the actuation device to have a housing cover, which is disposed preferably on the bottom end of the filter housing in a detachable manner and is provided with control cams and entrains an end cap of the filter element during operation in such a way that the shut-off device can be swiveled between the open and the blocking position and vice versa via the filter element and the connecting device. When the housing cover is opened or removed from the rest of the filter housing, fluid can no longer escape from the inlet and the outlet and reach the outside, as explained above, in particular if the inside of the filter housing is emptied via a bleed screw after the shut-off device has been operated. With the complete opening and removal of the housing cover, the filter element is completely removed from the other filter device via the housing cover, which is rendered possible by a latching connection between the lower end cap and the adjacent housing cover.

In a further preferred embodiment of the filter device according to the invention, provision is made for the one element cap of the filter element to have two cap parts, which are interconnected in a spring-elastically yielding manner, and for the one cap part to receive the element material of the filter element at the bottom end, and for the other cap part to comprise projections having guide bevels and abutment surfaces, which interact with the control cams on the housing cover. When the new element is inserted into the housing cover, it is screwed onto or into the bottom end of the free lower end of the other filter housing, and the element is co-rotated by the control cams in the housing cover and the projections on the lower cap part of the lower end cap of the filter element. When the housing cover is screwed on or in, the guide bevels of the projections on the lower cap part are used for this purpose, and when it is screwed off or unscrewed, the abutment surfaces opposite from the guide bevels are used as part of the said projections of the end cap part.

In a further preferred embodiment of the filter device according to the invention, provision is made for the housing cover to be screwed into or onto the bottom end of the remaining, cup-shaped filter housing as part of the latter, and for the thread pitch of this connecting area to be not as steep as the interengaging connecting threads of the connecting device, between the shut-off device and an adjacently disposed element cap of the filter element. As the housing cover is screwed onto or into the other filter housing, the upper thread on the upper end cap visibly comes into engagement with the assigned thread in the partition wall of the shut-off device, and once a stop position between the threaded sections has been reached, the shut-off device can also be swiveled between the open and closed position via the housing cover and its control cams as part of the shut-off device by entraining the filter element accordingly.

Because the thread pitch of the connecting area is preferably not as steep as the interengaging connecting threads of the connecting device, a relatively large infeed path for the thread of the upper end cap can be achieved with a small number of turns on the housing cover, improving handling and permitting rapid change operations for a filter element. Due to the aforementioned different pitch of the threads on the housing cover and on the element cap, the filter element is also subject to an axial travel motion, which can be compensated by the spring segments that interconnect the two cap parts of the lower end cap in a spring-elastically yielding manner. In this way, any axial play of the filter device components can also be reliably compensated, such that tight tolerances do not have to be maintained during manufacture, which in turn reduces manufacturing costs.

Further advantages of the solution according to the invention are the subject of the dependent claims.

Below, a filter device according to the invention is explained in more detail with reference to the drawing. In the figures, in general view, not to scale,

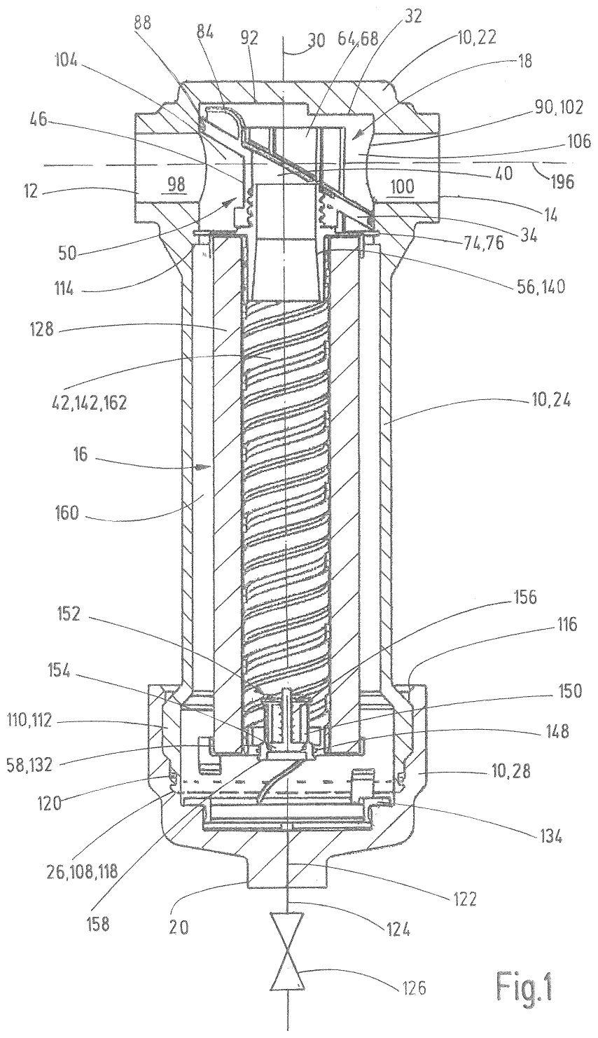

FIG. 1 shows a schematically simplified longitudinal section through a filter device according to the invention in its vertical operating or use position;

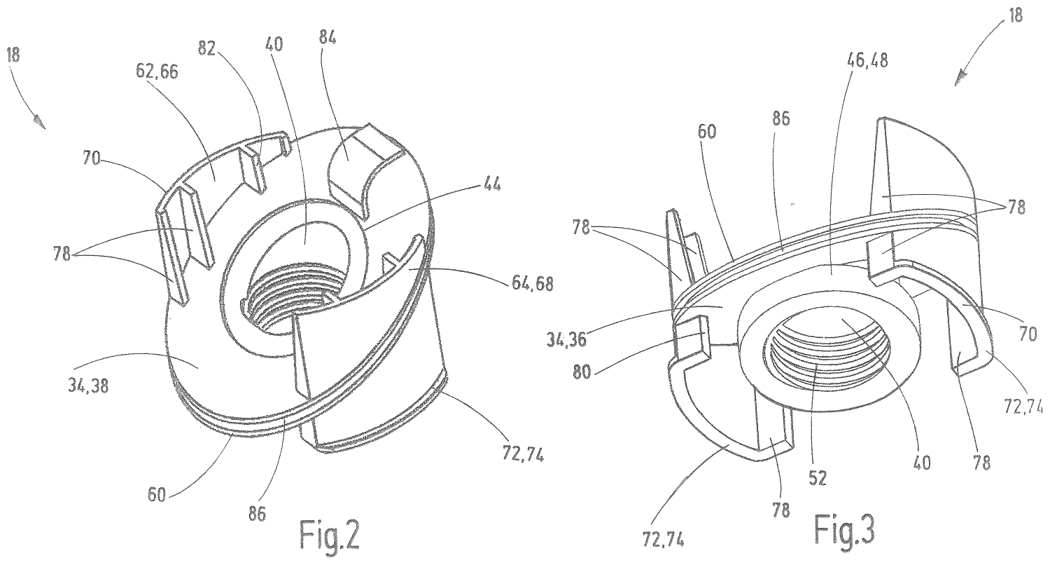

FIG. 2 shows a perspective oblique top view of the shut-off device of the filter device of FIG. 1 in an individual representation;

FIG. 3 shows a perspective oblique view of the shut-off device of FIG. 2 from below;

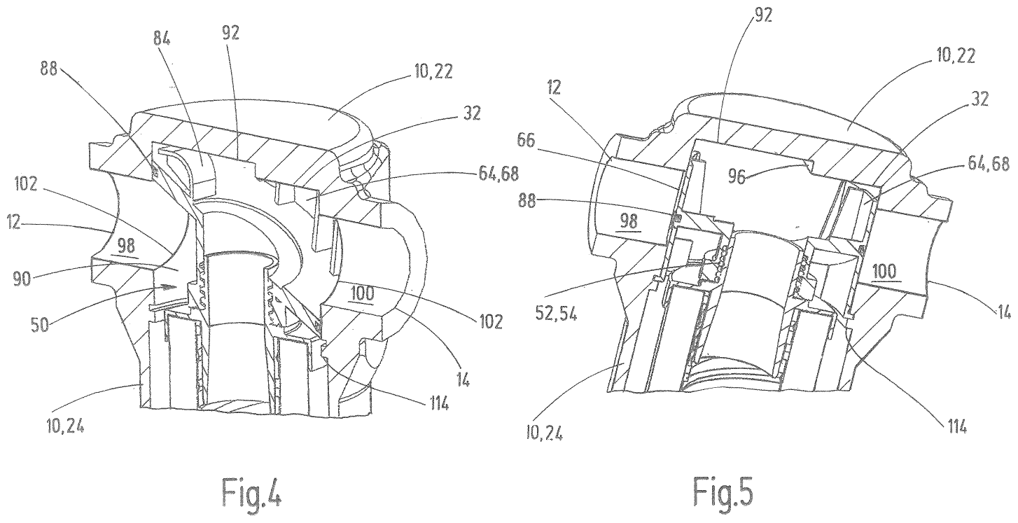

FIG. 4 shows a perspective oblique view of a partial longitudinal section of the filter device of FIG. 1 in the area of its filter housing head, wherein the shut-off device of FIGS. 2 and 3, which is at least partially accommodated in the filter housing head, is shown in its open position;

FIG. 5 shows a perspective oblique top view of a partial longitudinal section of the filter device of FIG. 1 in the area of its filter housing head, wherein the shut-off device is shown in its locked position;

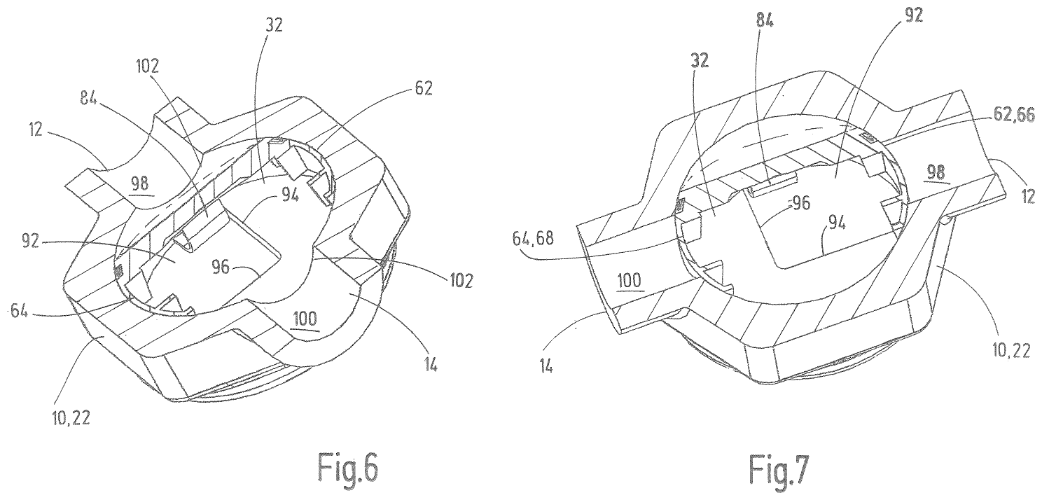

FIGS. 6, 7 each show a perspective oblique view from below of a schematically simplified cross-section through the filter housing head of the filter device of FIG. 4 and FIG. 5, respectively;

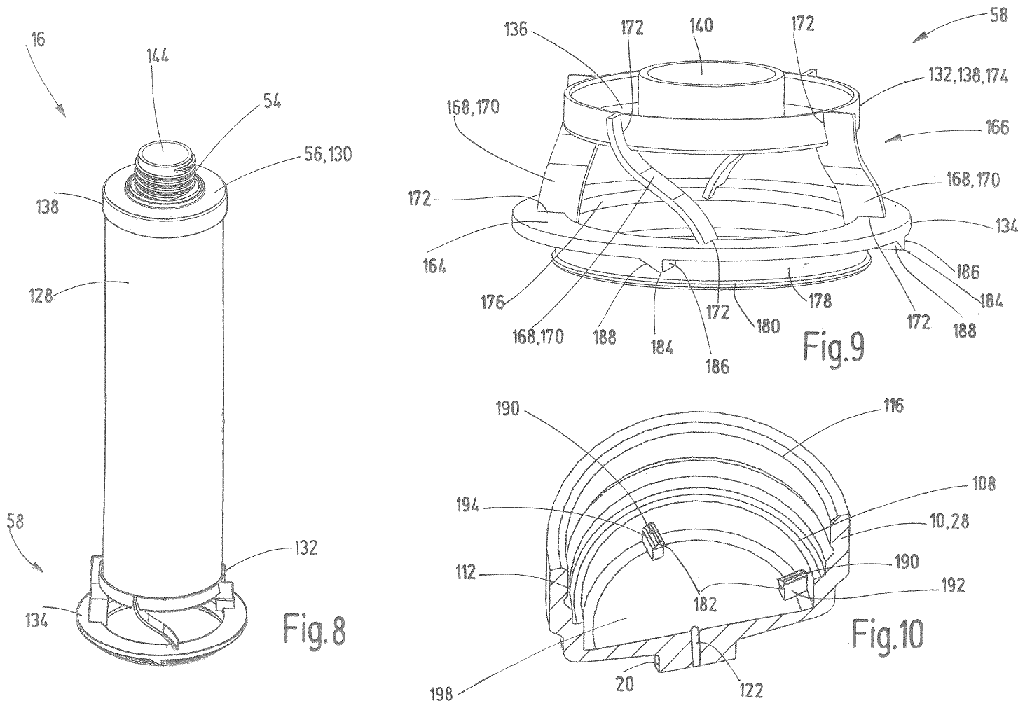

FIG. 8 shows a perspective oblique view from above of a filter element of the filter device of FIG. 1 shown in individual representation and used as a replacement element;

FIG. 9 shows a perspective oblique top view of a lower end cap of the filter element of FIG. 8; and

FIG. 10 shows a perspective oblique top view of a longitudinal cross-section of a housing cover of the filter device of FIG. 1.

FIG. 1 shows a filter device according to the invention having a filter housing 10, which has a port 12 as the inlet for unfiltered matter and another port 14 as the outlet for filtrate. As a rule, the inlet 12 and the outlet 14 are inherent components of a hydraulic circuit of a hydraulic system, which is not shown in more detail.

A filter element 16 is replaceably accommodated in the filter housing 10 and a shut-off device 18 is provided between the inlet 12 and the outlet 14, which shut-off device 18 can be moved by an actuation device between an open position, in which the shut-off device 18 releases the fluid-conveying connection between the inlet 12 and the outlet 14, and a blocking position, in which the shut-off device 18 blocks this fluid-conveying connection.

Disposed in the open position, the shut-off device 18 is used to open the fluid-conveying connection between the inlet 12 and the outlet 14 and also for routing the flow of unfiltered matter and the filtrate flow in the filter housing 10 and, disposed in the blocking position, it is only used to shut off the fluid-conveying connection.

The filter housing 10 has a filter housing head 22, which is integrally adjoined by a cylinder housing part 24. At its end facing away from the filter housing head 22, the cylinder housing part 24 has an opening 26, which can be closed by a filter housing cover 28, which can be removed from the cylinder housing part 24 and connected thereto in a detachable manner. The two ports 12,14 are provided in the filter housing head 22 and can be connected to rigid fluid lines of the hydraulic system in a fluid-conveying manner, which fluid lines are not shown. The cylindrical filter element 16 is replaceably disposed in the filter housing 10. Viewed in the direction of a longitudinal axis 30 of the filter device, the shut-off device 18 is inserted as an independent component into the filter housing head 22 between a bottom 32 of the filter housing head 22 and the filter element 16 and, viewed in the radial direction, between the two ports 12, 14.

The shut-off device 18 has a partition wall 34 that is obliquely inclined with respect to the longitudinal axis 30 of the filter device. Then, the partition wall 34 has two elliptical wall surfaces 36, 38 oriented in parallel to each other, each forming an angle of approximately 60 degrees between itself and the longitudinal axis 30 of the filter device. A projection of the respective wall surfaces 36, 38 in the direction of the longitudinal axis 30 of the filter device onto a fictitious first plane having the longitudinal axis 30 of the filter device as a normal is a circle having a diameter equal to the inner diameter of the filter housing head 22.

A central fluid duct 40 extends through the partition wall 34 in the direction of the longitudinal axis 30 of the filter device. One end of the fluid duct 40 facing the filter element 16 opens out into a cylindrical cavity 42 of the filter element 16, and the other end is formed by a central opening 44 of the partition wall 34 facing the bottom 32 of the filter housing head 22 of the filter device. The inner diameter of the fluid duct 40 widens in a step-like manner at its end section facing the bottom 32 of the filter housing head 22. The central fluid duct 40 of the partition wall 34 extends through a hollow cylindrical connecting sleeve 46, which is an integral part of the partition wall 34 and extends away from its one wall surface 36 in the direction of the longitudinal axis of the filter device without projecting beyond the lowest point of the partition wall 34 in its functional position. The outer diameter of the connecting sleeve 46 widens in its end section facing away from the partition wall 34 in a step-like manner in such a way that a full-circumference projection 48 extending in the radial direction away from the outer circumference of the connecting sleeve 46 is formed at this end section. At an end section of the inner circumference of the connecting sleeve 46 facing away from the partition wall 34, a female thread 52 is provided as part of a first connecting device 50 to connect to a male thread 54 of a first end cap 56 of the filter element 16, which is also part of the first connecting device 50.

Flush with the radial outer circumference 60 of the partition wall 34, the shut-off device 18 has two cylinder wall segments 62, 64 diametrically opposite with respect to the longitudinal axis 30 of the filter device, extending away from the partition wall 34 on both sides and are cylindrical in shape in accordance with the course of the circumference of the partition wall 34 and match each other. The part of the respective cylinder wall segment 62, 64 extending away from the one wall surface 36 of the partition wall 34 projects beyond the lowest point of the partition wall 34 disposed in its functional position in the axial direction, whereas the part of the respective cylinder wall segment 62, 64 extending away from the other wall surface 38 of the partition wall 34 does not project in the axial direction beyond the highest point of the partition wall 34 disposed in this way. The two cylinder wall segments 62, 64 have end faces 70 extending in parallel to each other and perpendicular and coaxial to the longitudinal axis 30 of the filter device. The one cylinder wall segment 62 and the other cylinder wall segment 64 form a first blocking element 66 of the partition wall 34 for the inlet 12 and a second blocking element 68 of the partition wall 34 for the outlet 14, respectively.

At the end of the respective part of the cylinder wall segments 62, 64 facing away from the partition wall 34, which segment 62, 64 extend away from the one wall surface 36 of the partition wall 34, a projection forming a latch 72 projects radially outwards from said cylinder wall segments 62, 64, respectively. As part of a guide device 74, the two latches 72 engage in a guide groove 76 of the guide device 74 formed in the inner circumference go of the filter housing head 22, which guide groove 76 extends perpendicular and coaxially to the longitudinal axis 30, such that the latches 72 of the shut-off device 18 are guided in the guide groove 76 and the shut-off device 18 can be rotated about the longitudinal axis 30 of the filter device in the filter housing head 22.

A rib 78 extends away from each of the lateral end sections, as viewed in the circumferential direction, of each cylinder wall segment 62, 64 toward a fictitious second plane comprising the highest and lowest points of the partition wall 34 of the shut-off device 18 disposed in its functional position. The second plane is equal to the sectional plane shown in FIG. 1. The end 80 of the rib 78 facing away from the respective part of the cylinder wall segments 62, 64 extending away from one wall surface 36 of the partition wall 34, extends in parallel to the second plane. Between the two ribs 78 of the respective part of the cylinder wall segment 62, 64 extending away from the other wall surface 38 of the partition wall 34, two further ribs 78 extending away from this cylinder wall segment 62, 64 towards the second plane are provided, each spaced apart from the remaining ribs 78. Each end 82 of the ribs 78 facing away from the respective part of the cylinder wall segments 62, 64 extending away from the other wall surface 38 of the partition wall 34 extends in the axial direction at an angle away from the partition wall 34 and from the second plane, starting from the partition wall 34. The ribs 78 are used to stabilize the respective cylinder wall segments 62, 64.

In an area of the other wall surface 38 between the highest point of the partition wall 34 of the shut-off device 18 disposed in its functional position and the central opening 44 of the partition wall 34, starting from a point adjacent to the opening 44 in this area, a preferably spring-elastically yielding, band-shaped delimiting element 84 extends in an arcuate manner and spaced apart from the other wall surface 38 in an outward direction such that the free end section of the delimiting element 84 is aligned perpendicular to the longitudinal axis 30. In this case, the free end section of the delimiting element 84 projects beyond the partition wall 34 in the axial direction without projecting beyond it in the radial direction. The delimiting element 84 is mainly U-shaped and is oriented symmetrically with respect to the second plane.

Along its outer circumference 60, an annular groove 86 is formed centrally in the partition wall 34, in which groove 86 a sealing means 88 in the form of an annular seal is disposed, which in any rotational position of the shut-off device 18 rests against the inner wall 90 of the filter housing head 22 in a sealing manner.

A recess 92 is formed in the plane or flat inner surface of the circular bottom 32 of the filter housing head 22, which recess 92 is co-delimited by a first step 94 and a second step 96 in the bottom 32. The two steps 94, 96 extend from a common transition point in the center area of the bottom 32 of the filter housing head 22, aligned perpendicular to each other in a radial direction outwards up to the outer wall of the cylinder housing head 22, which is cylindrical in this area. The first step 94 and second step 96 of the bottom 32 of the filter housing head 22 are used as stops for the one and the other lateral faces of the free end section of the delimiting element 84, respectively. As a result, the rotation of the shut-off device 18 in the filter housing head 22, guided by means of the guide device 74, is limited to a rotation angle of 90 degrees between its open position, in which one lateral face of the free end section of the delimiting element 84 is in contact with the first step 94 of the bottom 32 of the filter housing head 22, and its blocking position, in which the other lateral face of the free end section of the delimiting element 84 is in contact with the second step 96 of the bottom 32 of the filter housing head 22. Provision is made for the blocking elements 66, 68 to not only completely cover and release the accesses 102 of the inlet 12 and the outlet 14, respectively, into the interior of the filter housing head 22 when the delimiting element 84 is in contact with the respective steps 94, 96 in the bottom 32 of the housing head 22, but to also completely cover and/or release when the delimiting element 84 spaced apart from each step 94, 96, is disposed closer to the one step 94, 96 than to the other step 94, 96. Also, between the rotational positions of the shut-off device 18, in which the blocking elements 66, 68 completely cover or release the accesses 102 of the inlet 12 and the outlet 14, there are rotational positions of the shut-off device 18 in which the accesses 102 are partially covered or released by the blocking elements 66, 68.

If the shut-off device 18 is disposed in its open position, the partition wall 34 uses its mutually opposite wall faces 36, 38 against which the flows are directed to route the flow of unfiltered matter and the filtrate flow separately from each other, wherein the central opening 44 of the partition wall 34 is connected to the further port 14 in a fluid-conveying manner.

Starting from the port 12 for the supply of the flow of unfiltered matter and starting from the further port 14 for the discharge of the filtrate flow, a respective cylindrical fluid duct 98, 100 extends radially through the filter housing head 22. As a result, the direction of flow of the fluid through the respective port 12, 14 is oriented mainly perpendicular to the longitudinal axis 30 of the filter housing 10. The longitudinal axis 30 of the filter housing 10 is equal to the longitudinal axes of the filter housing head 22, the cylinder housing part 24, the filter housing cover 28, the shut-off device and the filter element 16. The fluid ducts 98, 100 of the ports 12, 14 are formed opposite from each other in the filter housing head 22 in such a way that they have a common central axis 196 extending through their centers. The longitudinal axis 30 of the filter device and the central axis 196 of the ports 12, 14 intersecting perpendicularly, lie in the second plane.

In addition, when the shut-off device 18 is in its open position, the two blocking elements 66, 68 of the shut-off device 8 rest against the outside of the cylindrical inner wall 90 of the filter housing head 22 without closing the accesses 102 of the respective fluid duct 98, 100 extending from the respective ports 12, 14 into the cavity of the filter housing head 22.

At least in the open position of the shut-off device 18, the partition wall 34 of the shut-off device 18 is inclined with respect to the direction of flow of the fluid through the respective fluid duct 98, 100 of the ports 12, 14. In addition, the shut-off device 18 is disposed in its open position in the filter housing head 22 in such a way that, viewed in the direction of the longitudinal axis 30 of the filter device, a circumference 60 of the partition wall 34 is disposed in the area of the port 12 between the bottom 32 of the filter housing head 22 and the port 12 as well as in the area of the further port 14 between an inner circumferential step 114, which is provided in the area of the transition of the filter housing head 22 to the cylinder housing part 24, and the further port 14.

Based on this arrangement in the open position, the shut-off device 18 separates a flow chamber 104 disposed in the filter housing head 22, which is co-delimited by the one wall surface 36 of the partition wall 34, from a further flow chamber 106 disposed in the filter housing head 22, which is co-delimited by the other wall surface 38 of the partition wall 34. The fluid duct 98 of the port 12 opens out into the flow chamber 104 without deflection, and the further fluid duct 100 of the further port 14 opens out into the further flow chamber 106 without deflection. Fluid flowing through the fluid duct 98 of the port 12 flows against one wall surface 36 of the partition wall 34 in the flow chamber 104 and fluid flowing through the further fluid duct 100 of the further port 14 flows against the other wall surface 38 of the partition wall 34 in the further flow chamber 106. In so doing, the partition wall 34 seals the flow of unfiltered matter against the filtrate flow.

When the shut-off device 18 is in its blocking position, one blocking element 66 of the shut-off device 18 closes the access 102 of the inlet 12 into the inside of the filter housing head 22 and the other blocking element 68 closes the access 102 of the outlet 14 in a largely fluid-tight manner.

The inner diameter of the filter housing cover 28 is enlarged in the direction of the filter housing head 22, forming a step 108, and the outer diameter of the cylinder housing part 24 has an enlargement 110 at the end section facing the filter housing cover 28. For connecting the cylinder housing part 24 to the filter housing cover 28, the cylinder housing part 24 has, in the area of the enlargement 110 of its outer diameter, a male thread 112 for engaging with a matching female thread 112 provided at the end section of the inner circumference of the filter housing cover 28 facing the filter housing head 22, between its step 108 and its opening 116. The thread pitch of the connecting area 112 is not as steep as the interengaging connecting threads 52, 54 of the first connecting device 50 between the shut-off device 18 and the first element cap 56 of the filter element 16. When the cylinder housing part 24 and filter housing cover 28 are interconnected, the free end face 118 of the cylinder housing part 24 comes into contact with the step 108 of the filter housing cover 28. An annular groove 120 is provided at the outer circumference of the cylinder housing part 24 in the area between the threaded section 112 and its open end 26, which annular groove 120 accommodates a sealing ring 120 for sealing contact with the filter housing cover 28.

A central fluid duct 122 for discharging filtrate from the filter housing 10 can extend axially through the filter housing cover 28, the end of which filter housing 10 facing away from the filter element 16 being connected to a fluid line 124, in which a valve device 126 for releasing and blocking the fluid path thereto is provided. Preferably, however, the valve device 126 is integrated into the lower housing cover 28 (not shown).

The end of the filter element 16 is provided with two end caps 56, 58 between which the filtering filter material 128 extends.

The filter element 16 has the upper first end cap 56 enclosing the hollow cylindrical filter material 128 at its end facing the filter housing head 22, and a lower second end cap 58 enclosing the hollow cylindrical filter material 128 at its end facing away from the filter housing head 22 and facing the housing cover 28.

The first end cap 56 has a flat annular base part 130, which, extending coaxially and perpendicularly to the longitudinal axis 30 of the filter element 16, is in contact with the end face of the filter material 128, and a cap part 132 of the second end cap 58 has a disk-shaped base part 136. A cylindrical circumferential part 138 each, the inner surface of which is in contact with the outer circumference of the filter material 128, extends away from the radially outer end section of the base part 130 of the first end cap 56 and the one cap part 132 of the second end cap 58 in the direction of the filter material 128. From the radially inner end section of the base part 130 of the first end cap 56 and the base part 136 of the one cap part 132 of the second end cap 58, an abutment connector 140 extends in the direction of the filter material 128 into the cavity 42 of the filter material 128, between which and the filter material 128 a support tube 142 extending over the entire axial length of the filter material 128 is partially disposed.

From the radially inner end section of the base part 130 of the first end cap 56, a connection piece 144 further extends away in the direction of the filter housing head 22, on the outer circumference of which connection piece 144, as part of the first connecting device 50 , the male thread 54 is provided for engagement with the female thread 52 of the connection sleeve 46 of the shut-off device 18, which is also part of the first connecting device 50.

The base part 136 of one cap part 132 of the second end cap 58 has a central opening 148 delimited by a cylindrical part 150 projecting slightly toward the housing cover 28, spaced radially apart from the abutment connector 140 of this cap part 132, and having a bypass valve 152. Thus, a valve closing body 154 is guided in the cylinder part 150, which valve closing body is preloaded in the direction of the housing cover 28 under the force of a compression spring 156, and in its closed position is in contact with a valve seat 158 formed in the cylinder part 150. If a threshold value of a pressure difference between the feed side 160 outside the filter element 16 and the filtrate side 162 inside the filter element 16 is reached during a blocking of the filter element 16, the fluid pressure present outside of the filter element 16 presses the valve closing body 154 against the force of the compression spring 156 into one of its opening positions, in which the bypass valve 152 interconnects the unfiltered fluid side 160 and the filtrate side 162 in a fluid-conveying manner.

In addition to the one cap part 132, the second end cap 58 comprises another cap part 134 having a flat annular base part 164 having an inner diameter approximately equal to the outer diameter of the base part 136 of the one cap part 132 and a larger outer diameter relative thereto.

One cap part 132 and the other cap part 134 of the second end cap 58 are interconnected by means of a spring-elastically yielding second connecting device 166 such that the other cap part 134 is spaced apart from the one cap part 132 in a direction away from the filter material 128. The second connecting device 166 has four connecting elements 168, each formed by a largely S-shaped flat band 170, one end part of which is connected to one cap part 132 and the other end part of which is connected to the other cap part 134 of the second end cap 58. The joints 172 of one cap part 132 to the one end part of the respective band 170 and the joints 172 of the other cap part 134 to the other end part of the respective band 170 are disposed at equiangular intervals, as viewed in the circumferential direction, namely at a distance of go degrees between two adjacent joints 172.

In particular, due to the different diameters of the base parts 136,164 of the one cap part 132 and the other cap part 134 of the second end cap 58, one end part of the respective band 170 engages with the outer circumference 174 of the circumferential part 138 and the end of the base part 136 of the one cap part 132 facing the other cap part 134, and its other end part engages with the inner circumference 176 and the side of the base part 164 of the other cap part 134 facing the one cap part 132.

The width of the bands 170 may be approximately five to eight times their material thickness, wherein the length of the bands 170 may be selected such that in an unloaded condition the axial distance between one cap part and the other cap part 132, 134 is approximately one-quarter to one-half the diameter of the one cap part 132. In this embodiment, the bands 170 provide sufficient elasticity when the entire second end cap 58 is manufactured as an integral component by injection molding from a suitable plastic material.

A connector 178 extends from the radially inward end section of the base part 164 of the other cap part 134 of the second end cap 58, in a direction away from the filter element material 128 and toward the housing cover 28. A fully circumferential projection forming a latch 180 for latching engagement with snap lugs 182 on the housing cover 28 extends radially outwards from the free end of the connector 178 of the other cap part 134. On the end of the base part 164 of the other cap part 134 of the second end cap 58 facing away from one cap part 132, four nose-shaped projections 184 are provided at equiangular intervals as viewed in the circumferential direction. Viewed in the circumferential direction, each projection 184 has an abutment surface 186 extending in the axial direction away from the base part 164 at one end, and on the other end opposite from the one end a guide slope 188 extending obliquely with respect to the abutment surface 186 and the longitudinal axis 30.

Four control cams 190 are provided on the inside of the bottom 198 of the housing cover 28, and, projecting in the axial direction, extend away from the bottom 198 of the housing cover 28 at equiangular intervals as viewed in the circumferential direction. Viewed in the circumferential direction, each snap cam 190 has an abutment surface 192 extending away from the bottom 198 in the axial direction at one end and a contact bevel 194 at the other end opposite the one end. At the end facing the center of the housing cover 28 and at its free end, each snap cam 190 further includes the radially inwards projecting snap lug 182 for latching engagement with the latch 180 at the other cap part 134 of the second end cap 58.

The actuation device zo in the form of an external hexagon is provided centrally at the outside of the filter housing cover 28.

In FIG. 1, the filter housing cover 28 is screwed to the cylinder housing part 24 and the shut-off device 18 is disposed in its open position, in which the fluid-conveying connection between the inlet 12 and the outlet 14 is released by the shut-off device 18. The threads 52, 54 of the first connecting device 50 between the shut-off device 18 and the first end cap 56 fully engage with each other. At the same time, the second connecting device 166 spring-elastically pre-loads the other cap part 134 of the second end cap 58 toward the housing cover 28, such that the base part 164 of its other cap part 134 of the second end cap 58 rests on the free end faces of the control cams 190 of the housing cover 28, between which the nose-shaped projections 184 of the other cap part 134 are disposed. In addition, the latch 180 of the second end cap 58 is in latching engagement with the snap lugs 182 formed on the control cams 190 of the housing cover 28.

The functioning of the filter device according to the invention is explained in more detail below:

If, starting from the state of the filter device shown in FIG. 1, the filter element 16 is to be removed from the filter housing, the inlet 12 is first depressurized, for instance by switching off a pressure supply device not shown in the figures, wherein the outlet 14 is depressurized at all times. Subsequently, the actuation device zo is used to rotate the filter housing cover 28 in an unscrewing direction about the longitudinal axis 30 of the filter device. During this rotational motion, the abutment surfaces 192 of the control cams 190 of the housing cover 28 come into contact with the abutment surfaces 186 of the projections 184 of the second end cap 58, such that the housing cover 28 causes the entire filter element 16 to rotate in the unscrewing direction via its second end cap 58. In particular, due to the pressureless inlet 12 and outlet 14, no fluid pressure acts on the sealing means 88 of the shut-off device 18, so that in a first step the filter element 16 can be used to easily entrain or rotate the shut-off device 18 by 90 degrees from its open position, in which one end of its delimiting element 84 is partially in contact with the first step 94 of the recess 92 in the bottom 32 of the housing head 22, into its closed position, in which the other end of the delimiting element 84 is partially in contact with the second step 96 of the recess 92 in the bottom 32 of the housing head 22.

Once in the locked position, the first blocking element 66 of the shut-off device 18 closes the inlet 12 and its second blocking element 68 closes the outlet 14 of the filter device. In this way, the fluid supply to the filter housing 10 and the fluid discharge from the filter housing 10 can be shut off, rendering opening the filter housing 10 and replacing a used filter element 16 with a new element 16 much easier, because there is no need to anticipate a constant flow of unpressurized fluid in the form of unfiltered matter or air and/or filtrate.

After the delimiting element 84 of the shut-off device 18 has reached the stop in the form of the second step 96 and by this is subjected to a restraint, with continued rotation of the filter element 16 in the unscrewing direction, in a second step the threads 52, 54 of the first connecting device 50 are completely disengaged in the same way as the threads 112 between the cylinder housing part 24 and the housing cover 28.

When the housing cover 28 is removed from the cylinder housing part 24, the housing cover 28 entrains the filter element 16 due to the existing latching connection between the control cams 190 of the housing cover 28 and the latch 180 of the second end cap 58, which are removed from the filter housing 10 as a unit.

If the filter element or another filter element 16 is now to be inserted into the filter device, the actuation device zo is used to rotate the filter housing cover 28, which is placed on the cylinder housing part 24 and is connected in a latching manner to the filter element 16 inserted into the filter housing head 22, in a screw-on direction about the longitudinal axis 30 of the filter device. In the process, the contact bevels 194 of the control cams 190 of the housing cover 28 come into contact with the guide bevels 188 of the projections 184 of the second element cap 58.

During this initial engagement of the female thread 112 of the housing cover 28 with the male thread 112 of the cylinder housing part 24, the control cams 190 of the housing cover 28 can pass the projections 184 of the second element cap 58 without entraining the filter element 16, because the filter element 16 has a clearance in the axial direction in the filter housing 10, so that the second connecting device 166 is not yet preloaded. As the female thread 112 of the housing cover 28 progressively engages the male thread 112 of the cylinder housing part 24, after the male thread 54 of the first end cap 56 has come into contact with the female thread 52 of the shut-off device 18, the spring-elastic second connecting device 166 is preloaded. When the second connecting device 166 is sufficiently preloaded, the control cams 190 of the housing cover 28 are prevented from passing over the projections 184 of the second element cap 58, such that the housing cover 28, the contact bevels 194 of the control cams 190 resting against the guide bevels 188 of the projections 184 of the second element cap 58, causes the entire filter element 16 to rotate in the screw-on direction via its second end cap 58.

Owing to the different pitch of the thread 52, 54 of the first connecting device 50 compared to the pitch of the threaded section 112 between the cylinder housing part 24 and the housing cover 28, when the housing cover 28 is screwed on, the threads 52, 54 of the first connecting device 50 are engaged with each other and at the same time the second connecting device 166 is immobilized. As a result, filter elements 16 of different axial lengths can be used as part of a clearance compensation in the filter housing 10 and the axial motion of the filter element 16 relative to the cylinder housing head 22 and the cylinder housing part 24 is compensated for during the screw-on and unscrewing process.

Only when the female thread 112 of the housing cover 28 is fully engaged with the male thread 112 of the cylinder housing part 24 is the shut-off device 18 co-rotated by the filter element 16, starting from its locked position into its open position, thus establishing the function of the filter.

1. A filter device having a filter housing (10) that comprises at least two ports (12, 14), such as an inlet for unfiltered matter and an outlet for filtrate, and accommodates a replaceable filter element (16), characterized in that by a shut-off device (18) a fluid-conveying connection between the inlet (12) and the outlet (14) that exists in an open position, is blocked in a blocking position, and in that by an actuation device (20) the shut-off device (18) can be brought into these individual positions.

2. The filter device according to claim 1, characterized in that the shut-off device (18) has a partition wall (34), which, viewed in the longitudinal direction of the filter housing (10), is set at an angle, the top face of which partition wall (34), in the open position, opens out into one port (14) and the underside of which partition wall (34) opens out into the respective other port (12), and in that the partition wall (34), brought into the blocking position, preferably by swiveling, by means of the actuation device (20), shuts off at least the inlet by means of at least one blocking element (66, 68).

3. The filter device according to claim 1, characterized in that the elliptically configured partition wall (34) has sealing means (88) along its outer circumference (60) and that the partition wall (34) is penetrated by an opening (44), which is fluidically connected to the interior (42) of the hollow cylindrical filter element (16).

4. The filter device according to claim 1, characterized in that the opening (44) in the partition wall (34), as part of a connecting device (50), is at least partially delimited by a threaded section (52), which is used to secure the filter element (16) in the filter housing (10) via its associated threaded section (54) as a further part of the connecting device (50).

5. The filter device according to claim 1, characterized in that the partition wall (34) has at least one delimiting element (84), which interacts with adjacent housing parts (94, 96) such that a guide device (74) is used to guide the partition wall (34) between the open position and the closed position, preferably by 90°, in a swiveling manner, by means of the actuation device (20) in the filter housing (10).

6. The filter device according to claim 1, characterized in that the guide device (74) has at least one latch (72), preferably at the shut-off device (18), which latch (72) is accommodated in a guide groove (76), preferably in the filter housing (10), in such a manner that the shut-off device (18) can be rotated radially and in the axial direction, viewed along the longitudinal direction of the filter housing (10), is accommodated in the filter housing (10) in a stationary manner.

7. The filter device according to claim 1, characterized in that the inlets and outlets of the ports (12, 14) are disposed, as viewed in the longitudinal direction of the filter housing (10), diametrically opposite from each other in the filter housing (10), extending in at least one and the same plane.

8. The filter device according to claim 1, characterized in that the actuation device (20) has a housing cover (28), which is disposed, preferably at the bottom end, on the filter housing (10) in a detachable manner and is provided with control cams (190) and entrains an end cap (58) of the filter element (16) during operation in such a way that the shut-off device (18) can be swiveled between the open position and the blocking position and vice versa via the filter element (16) and the connecting device (50).

9. The filter device according to claim 1, characterized in that the one end cap (58) of the filter element (16) has two cap parts (132, 134) which are interconnected in a spring-elastically yielding manner, and in that one cap part (132) receives the element material (128) of the filter element (16) on the bottom end, and in that the other cap part (134) has projections (184) with guide bevels (188) and abutment surfaces (186), which interact with the control cams (190) on the housing cover (28).

10. The filter device according to claim 1, characterized in that the housing cover (28) can be screwed into or onto the bottom end of the remaining, cup-shaped filter housing (10) as part of the latter, and in that the thread pitch of this connecting area (112) is not as steep as the interengaging connecting threads (52, 54) of the connecting device (50) between the shut-off device (18) and an adjacently disposed element cap (56) of the filter element (16).
